(19) United States
(12) Patent Application Publication
(10) Pub. No.: US 2004/0159460 A1
(43) Pub. Date: Aug. 19, 2004

(54) Conductor structure

(76) Inventors: George Passiopoulos, London (GB); Ilpo Kokkonen, Oulu (FI); Olli Salmela, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/481,252

(22) PCT Filed: May 21, 2002
(86) PCT No.: PCT/IB02/02808

(30) Foreign Application Priority Data
Jun. 18, 2001 (GB) 0114818.8

(51) Int. Cl. H01B 7/08

(52) U.S. Cl. 174/117 FF

(57) ABSTRACT

A conductive structure having a conductor for carrying a signal at a one or more operating frequencies of the structure, the conductor comprising: at least two electrically conductive strips spaced apart by a dielectric and arranged in parallel to extend from a first node to a second node, the conductive strips being interconnected between the nodes by at least one inter-strip electrically conductive connection through the dielectric; the maximum physical dimension of the or each inter-strip connection and the maximum physical separation of potentially successive inter-strip connections being equal to or less than one quarter of the free space wavelength corresponding to the minimum operating frequency of the structure.

The invention relates to a conductor structure.

Conductive transmission line structures are used to carry signals in electrical equipment. For signals having frequencies in the low microwave region, conductor losses can dominate the overall loss per unit length and Q (quality) factor of conductor based transmission line structures. Normally it is desired to reduce conductor losses.

In the case of flat conductors, traditionally the following solutions have been adopted in order to reduce the effect of conductor losses:

a. Use of wider width or/and thicker conductors.

b. Use of conventional conductors with higher conductivity.

c. Use of superconductors.

In most practical cases the wider width conductor option is limited by design due to RF impedance requirements, while it has the disadvantage of increased area to implement it. On the other hand the thickness of the conductor in a standard manufacturing process is not a variable, while its effectiveness to reduce loss decreases as frequency increases due to the skin effect.

Even when using conductors of the highest conductivity such as gold (Ag), copper (Cu) or silver (Au), the conductor's losses may be still quite significant.

Superconductors are expensive to fabricate-in quantities and require a bulky cooling system that increases significantly the overall cost and size of the circuit/system.

There is therefore a need for an improved form of conductive structure that, in comparison with conventional structures, may reduce losses especially in the microwave region, may require a smaller area to achieve a certain RF impedance, and/or be susceptible of implementation at lower cost.

According to one aspect of the present invention there is provided a conductive structure having a conductor for carrying a signal at a one or more operating frequencies of the structure, the conductor comprising: at least two electrically conductive strips; and a ground plane associated with the conductor; wherein: the at least two electrically conductive strips are spaced apart by a dielectric and arranged in parallel to extend from a first node to a second node, the conductive strips being interconnected between the nodes by at least one inter-strip electrically conductive connection through the dielectric; and the maximum physical dimension of the or each inter-strip connection and the maximum physical separation of potentially successive inter-strip connections being equal to or less than one quarter of the free space wavelength corresponding to the minimum operating frequency of the structure; and wherein: the ground plane is configured to as to include a plurality of localised voids therein.

Preferably there is a ground plane associated with the conductor.

According to a second aspect of the present invention there is provided a conductive structure having a conductor extending from a first node to a second node and a ground plane for the conductor extending parallel with the conductor and spaced from it, the ground plane being configured to as to include a plurality of localised voids therein.

The electrically conductive strips and the or each inter-layer electrically conductive connection suitably provide a transmission line.

The ground plane conveniently extends parallel with the strips and spaced from them. The ground plane can be configured to as to include a plurality of localised voids therein.

Preferably the maximum physical dimension of the or each inter-strip connection and the maximum physical separation of potentially successive inter-strip connections being equal to or less than one fifth or one sixth of the free space wavelength corresponding to the minimum operating frequency of the structure. The operating frequency or frequencies of the structure may be intended or rated operating frequencies.

The structure may comprise at least three electrically conductive strips spaced apart by a dielectric and arranged in parallel to extend from the first node to the second node, the conductive layers all being interconnected between the nodes by inter-strip electrically conductive connections through the dielectric.

The dielectric is suitably a ceramic.

The structure can conveniently be formed by HTCC or LTCC.

The strips can conveniently be flat and/or planar. The strips preferably run parallel to each other.

The dielectric is preferably formed of a plurality of dielectric layers, the strips being located between the layers, and each inter-strip connections passing through at least one layer.

The conductive structure may suitably comprise a dielectric located between the conductor and the ground plane.

Each inter-strip connection may, for instance, comprise a via or a post.

Adjacent strips are preferably interconnected at a plurality of locations along their lengths. The number of locations is preferably at least 5 or at least 10. The locations are preferably equally spaced. Preferably the strips are not interconnected between the said locations.

The conductive structure is suitably arranged in a circuit so as to be fed with radio frequency signals. Another aspect of the invention is a circuit comprising the conductive structure, the circuit being arranged to feed radio frequency signals to the conductive structure.

The ground plane is preferably flat and/or planar. The ground plane may comprise at least two strips interconnected at locations along their lengths so as to define the voices between the strips and the interconnections. The ground plane may arranged to operate in QTEM mode. The structure may be formed by MCIT.

Preferably the voids are regularly spaced.

The present invention will now be described by way of example with reference to the accompanying drawings, in which:

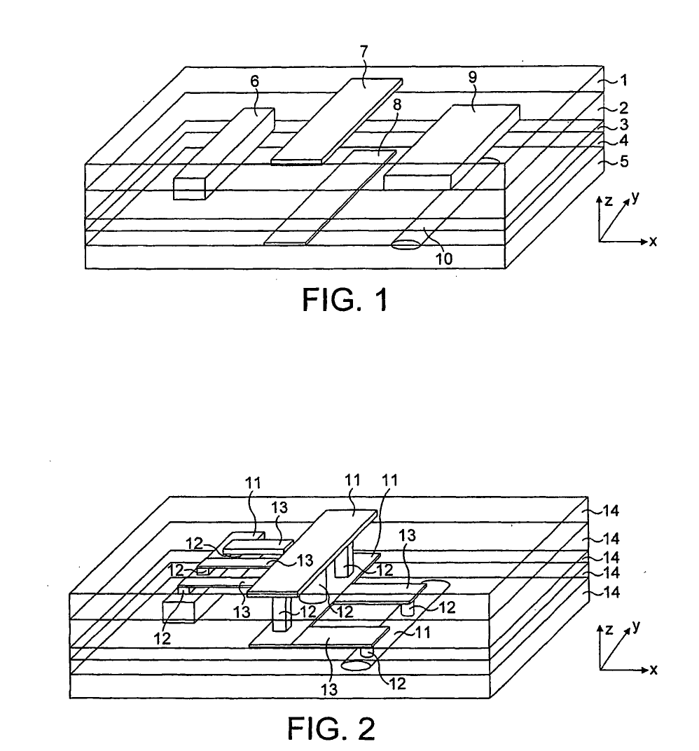

FIG. 1 shows a general multiconductor-multilayer system;

FIG. 2 shows a composite conductor with repeated interconnecting conductors across an energy propagation direction y;

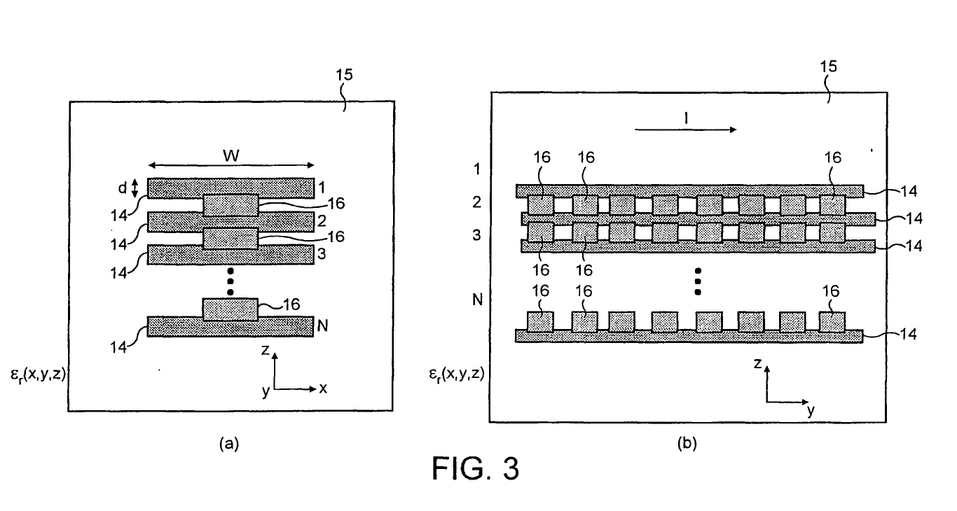

FIG. 3 illustrates an analysis of an example of a stacked composite conductor structure;

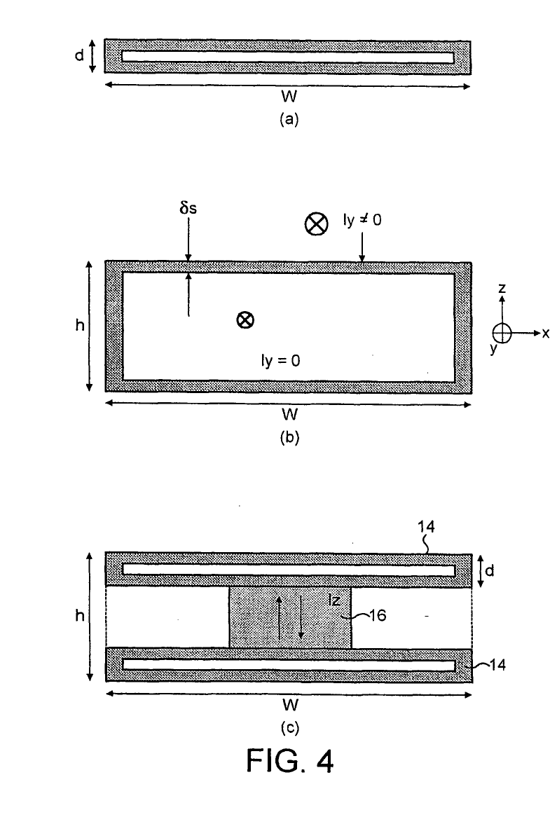

FIG. 4 illustrates conductor cross-coupling for high frequencies;

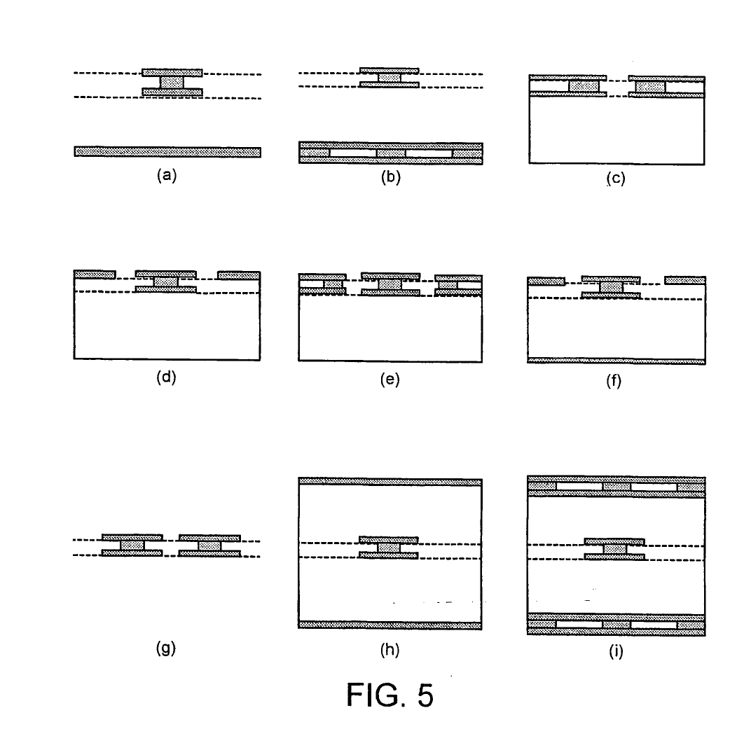

FIG. 5 illustrates conductor structures;

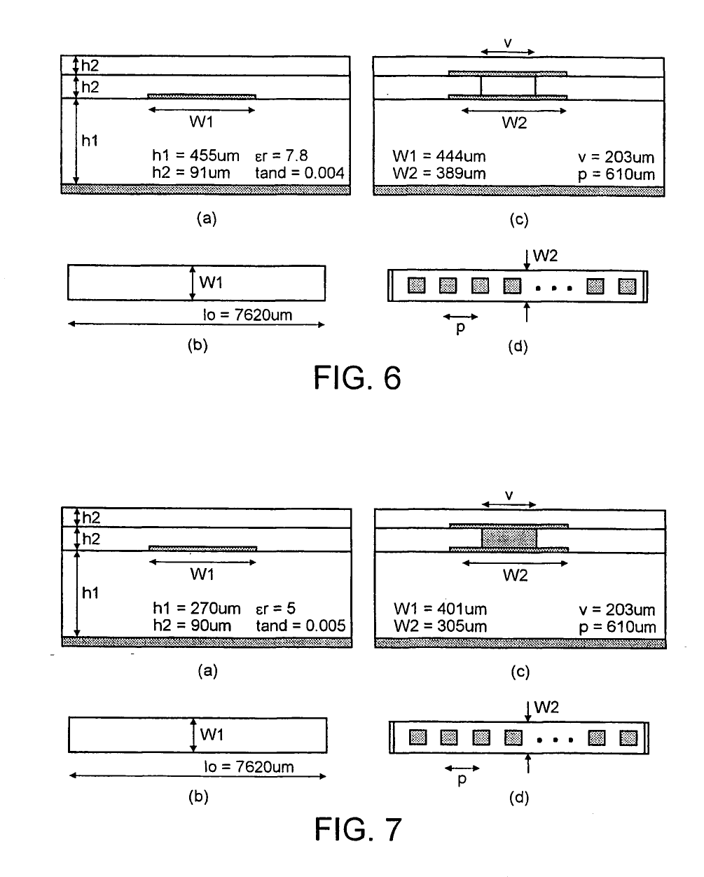

FIGS. 6 and 7 show comparisons of conventional microstrips and composite conductor microstrips;

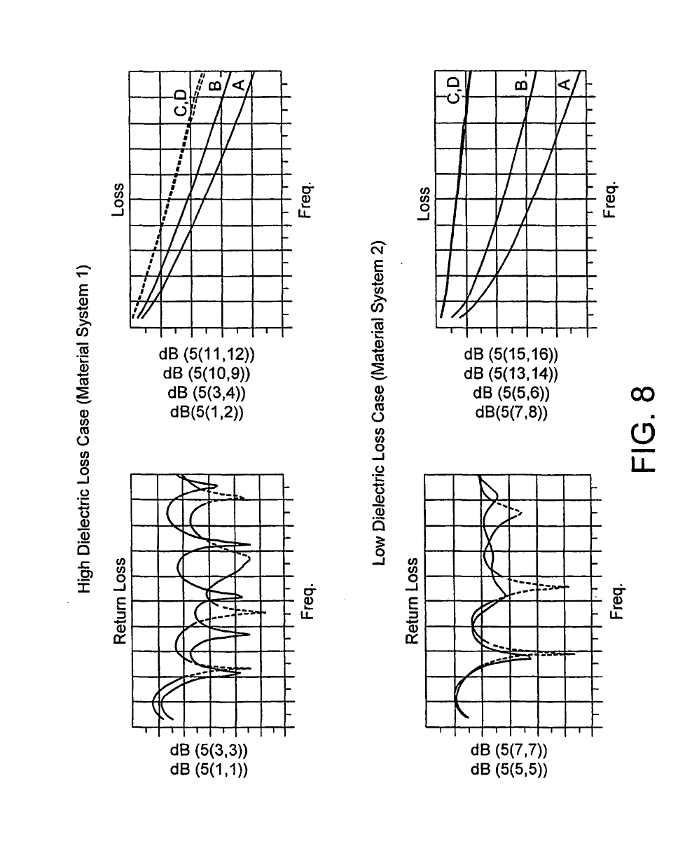

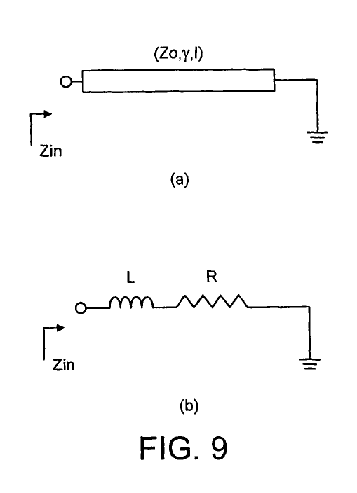

FIG. 8 shows simulation results for example transmission lines; FIG. 9 shows illustrative circuits;

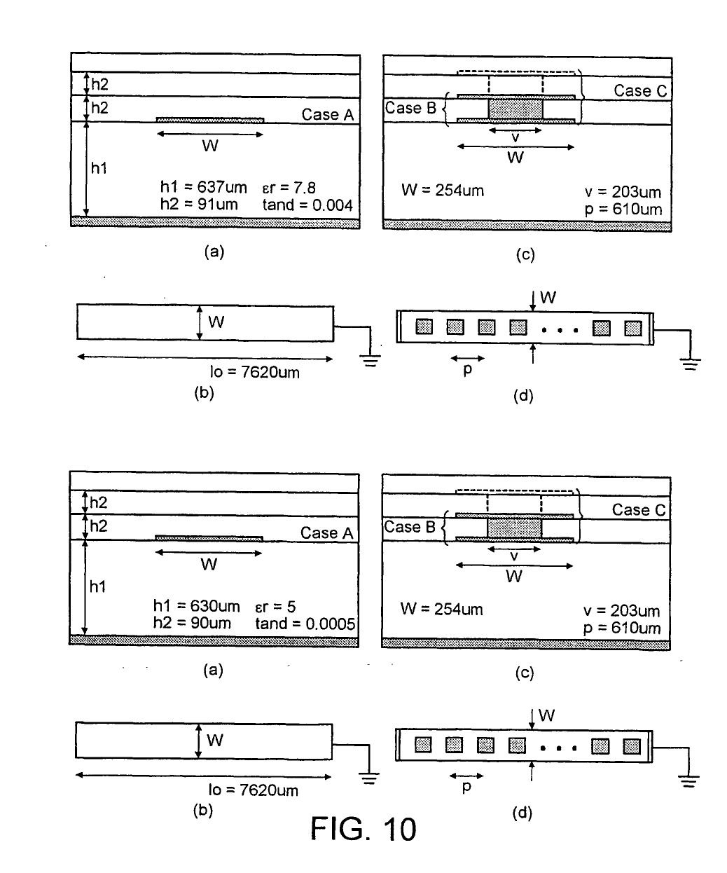

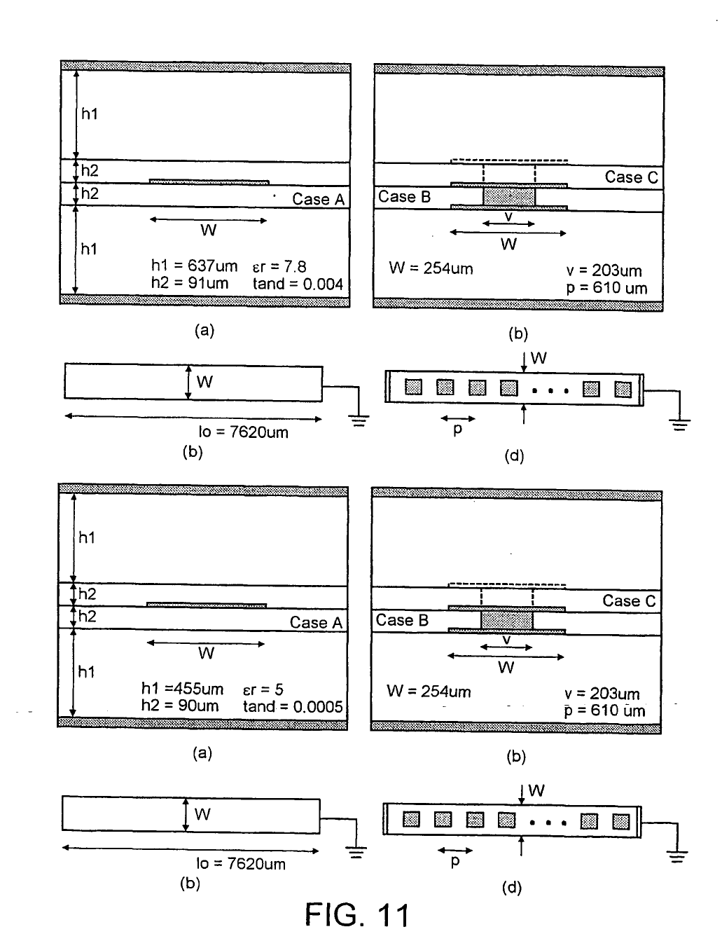

FIGS. 10 and 11 show comparisons of conventional microstrips and composite conductor microstrips;

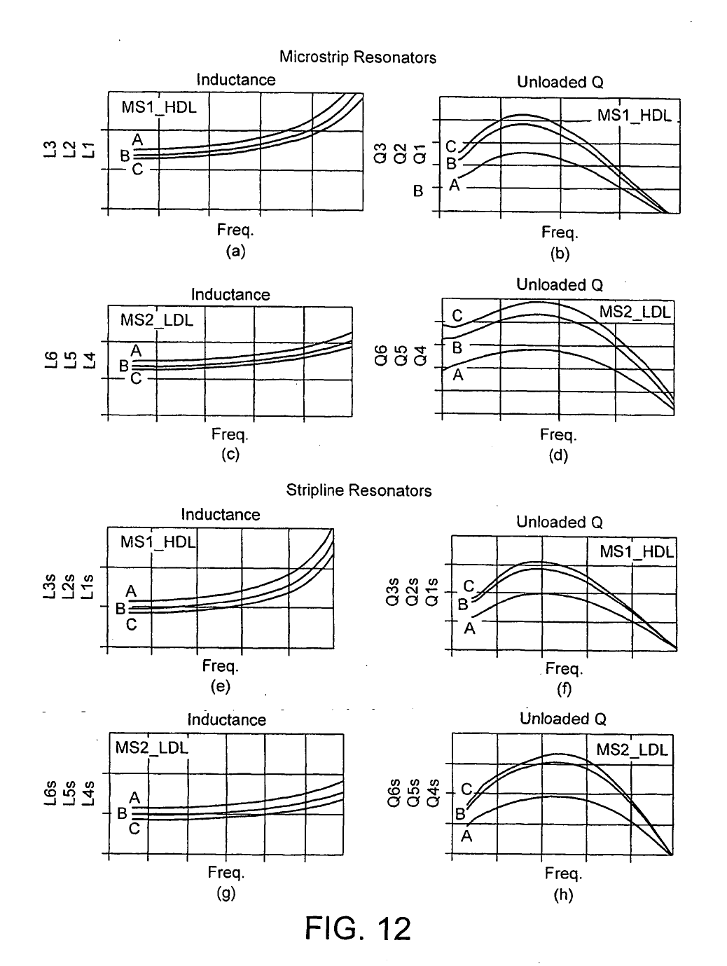

FIG. 12 shows simulation results for inductance and Q factor properties of conductive structures; and

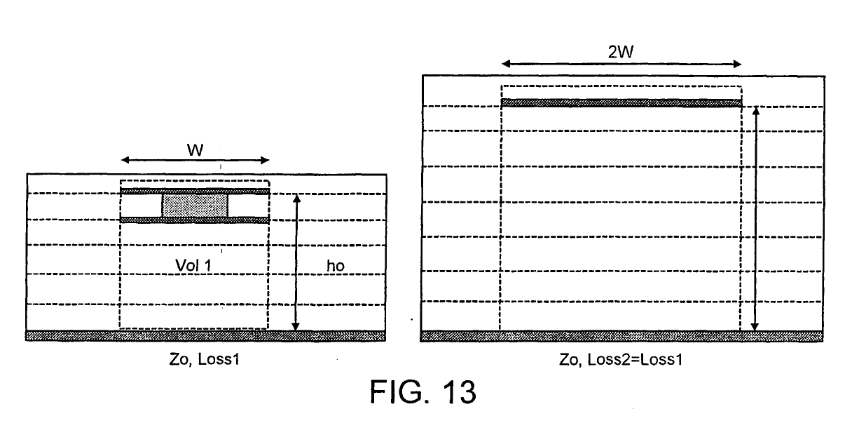

FIG. 13 shows a comparison of a conventional microstrip and a composite conductor microstrip.

There will now be described a generic composite conductor structure that may be utilised in conductor based transmission line systems. The structure can conveniently be implemented in a multi-layer multi-conductor format. Examples of the composite conductor structure have been found to have low conductor loss and potentially reduced area factor when compared with conventional ‘single-conductor on a single layer’ structures.

Assume a general multi-conductor, multi-layer dielectric medium or system in which conductors can reside on the Interfaces of semi-insulative layers. The conductors can have arbitrary number, shape, conductive properties and thickness. The semi-insulative layers may be of arbitrary number, thickness and dielectric properties. The interfaces between the conductors and the dielectric layers may be arbitrarily defined. An example of such a multilayer/multiconductor system is shown in FIG. 1. In FIG. 1 reference numerals 1 to 5 indicate dielectric layers and reference numerals 6 to 10 indicate conductors. A composite conductor may be considered to be a conductive structure formed by the arbitrary inter-connection of two or more conductors in such an arrangement, at least one of which resides on a different semi-insulator layer interface/level from at least one other. The interconnections between the conductors may be formed through any appropriate way. For example, by means of pieces of conductive material of the same or different type, which may reside on the same interface/level, across a semi-insulative layer(s), or on different layer(s) interface(s)/level(s). The interconnections between the specified conductors across the direction of an arbitrary defined propagation direction should be repeated, in an either periodic or periodic way, but possibly in a different shape or form.

FIG. 2 shows an example of a composite conductor structure that fits the above definition. In the case described in FIG. 2, four initially individual conductors 11 were interconnected via the help of vias, posts 12, and planar conductors 13 to form a ‘composite conductor’ on various levels between dielectric layers 14. All the individual conductors 11 are electrically connected together. The interconnections were repeated in a different form across the assumed signal propagation direction y.

If such composite conductor is used to transfer electrical or/and thermal energy then it may conveniently be a termed a composite conductor transmission line. The propagation properties of this transmission line will be determined by the geometrical and material characteristics of the composite conductor or conductors, the technique that is used to feed the electrical/thermal energy into the conductors and the geometrical and material characteristics of its surroundings.

For illustration, the composite conductor of FIG. 3 will be considered. It will be assumed that the composite conductor is standing alone within an arbitrary dielectric medium. Since in this instance only the properties of the conductor are to be studied, the material properties of the embedding dielectric do not come into the calculations.

Taking a theoretical approach, the composite conductor of FIG. 3 comprises N flat conductors 14 each on different successive levels separated by an arbitrary dielectric 15. They are effectively stacked on top of each other in the z direction and for simplicity we assume that they and have identical geometrical properties, namely width W and thickness d. Vias or posts 16 interconnect them periodically across the electric energy/current propagation direction y. The interdistance in the z direction between each conductor and the next, which determines the via length connection does not have to be the same as long, but it is selected to be very small in comparison to the wavelength corresponding to the frequency of the signal to be used. In addition the vias'/posts' diameters do not have to be the same since for the purposes of this analysis and for most practical purposes this should not be critical.

The above described conductor may be termed as a “stacked composite conductor” of order N. Such a “stacked composite” conductor is highly useful since it represents a most useful and practical case of the composite conductor concept for circuit applications.

The N=1 case corresponds to the conventional single layer conductor.

We assume that the proposed composite conductor (having N>1) is fed with current, and we also assume that this current is equally distributed across each of the N flat conductors with a uniform current distribution across their width W. The purpose of the vias is to short each conductor i.e. to put them on the same voltage potential. This is a sufficiently good approximation up to frequencies where the interconnecting vias' inductance can be considered negligible. It should be noted that the current is better fed from the conductor with identification number N/2, so as to effect a symmetrical current feeding.

We will calculate the conductor loss properties via the calculation of the effective conductor resistance. We will do this calculation in a simplified manner so as to capture the most salient characteristics, without having to resolve in complex mathematical expressions.

We will pursue 2 cases:

a. The conductor loss at DC/low frequencies.

b. The conductor loss at high frequencies.

DC/Low Frequency Case

The DC resistance of any single conductor with conductivity σ and cross-sectional area A and length I is given by

$${R}_{D C} = \frac{l}{σ \cdot A} = \frac{l}{σ \cdot ( W \cdot d )} \qquad ( 1 )$$

Where the area A has been substituted by its value for the case of a flat conductor with width W and thickness d. The differential change of DC resistance for a differential change in length is:

$$ⅆ {R}_{D C} = \frac{ⅆ l}{σ \cdot A} = \frac{ⅆ l}{σ \cdot ( W \cdot d )} \qquad ( 2 )$$

For the N conductor case if we assume that the vias are close enough to each other so as within the differential distance dl a pair of successive vias is included along the y direction then all differential resistors dR_{DC} are effectively in parallel. The 2 successive vias that span across the z direction all N conductors are setting the input and output nodes of the parallel combination.

For N resistors in parallel the total differential resistance is d_{RD}/N

Therefore the total DC resistance of the N conductors across the length I is:

$$\begin{matrix}{R}_{D C , N} = {\int }_{0}^{l} ⅆ {R}_{D C} = {\int }_{0}^{l} \frac{1}{N} \frac{ⅆ l}{σ \cdot A} = \frac{1}{N} {\int }_{0}^{l} \frac{ⅆ l}{σ \cdot A} = \frac{1}{N} \frac{l}{σ \cdot A} & ( 3 ) \\ ⇒ {R}_{D C , N} = \frac{{R}_{D C , 1}}{N} & ( 4 )\end{matrix}$$

The notation N and 1 in the subscripts denotes the DC resistance for a single and N conductors respectively.

From equation 4 it can be seen that the total DC resistance and therefore the corresponding conductor losses are divided by N for the composite conductor case, in comparison to the same conductors in parallel but not interconnected along their length.

The same result may have been intuitively deduced by noticing that since each conductor is short circuited by the vias, the DC physical equivalent would have been the “collapse” of the N conductors of width W to a single conductor of thickness N×d and width W. Therefore at DC the effective thickness is multiplied by N and therefore the overall area is multiplied by N.

The composite conductor is able to deliver lower conductor loss than a corresponding set of non-composite (non-connected) conductors.

High Frequency Case

In the high frequency case the resistance that determines the conductor losses in a single conductor is proportional to the skin effect resistance or surface resistance of the conductor given by:

$${R}_{s , 1} = \frac{l}{2 σ \cdot W {δ}_{s}} \qquad ( 5 )$$

Where W is the width of the conductor and δₛ is the skin depth of the conductor, which is a function of frequency and may be given as:

$${δ}_{s} = \sqrt{\frac{1}{π f μ σ \cdot }} \qquad ( 6 )$$

where f is the frequency and μ is the permeability of the conductive material.

Effectively the above surface resistance is the one that would result assuming an area A=2 W δₛ in relation (1). This expression is valid with reasonable approximation for W>>d.

Then, following the arguments of the previous DC/low frequency case one may again deduce that up to frequencies where the vias inductance is not important and the via pitch across the y direction is very small with respect to the wavelength then the resistance of the N conductors is divided by N. i.e.,

$$⇒ {R}_{s , N} = \frac{{R}_{s , 1}}{N} \qquad ( 7 )$$

Obviously in the high frequency range the vias will indeed have some inductance. The current will no longer be uniformly distributed across all metal conductors. The current distribution across the different conductors may also be affected by the position of the current feeding conductor. Nevertheless the above approximations are valid under the assumptions stated.

In the high frequency case since conductor thickness does not play any important role, the composite conductor may be viewed for loss calculations as a single conductor with approximately N times the width W of each single constituent conductor forming the composite conductor.

It is also worth noting that in high frequencies the stacked composite conductor may offer lower loss than an equivalent “thick” conductor, which effectively occupies the same “volume” as the composite conductor.

This is illustrated with reference to FIG. 4 and table 1.

TABLE 1

| | | | Stacked |
|---|---|---|---|
| Type of | Thin | Thick | Composite |
| Conductor | Single | Single | N = 2 |
| Effective Current | ˜2 W δs | ˜2 (W + h) δs | ˜4 W δs |
| Flow Area at high | | | |
| frequencies | | | |
| Ae | | | |
| Skin effect | (σ 2 W δs)⁻¹ | [σ 2 (W + h) δs]⁻¹ | (σ 4 W δs)⁻¹ |
| Resistance | | | |
| Rs per unit length | | | |

It may be easily deduced that at high frequencies when the thin conductor is of sufficient thickness so as its thickness is more than 2 skin depths and the width W of the thick conductor is larger than its thickness h, then the stacked composite conductor with N=2 of the same volume as the described thick conductor and comprising of 2 thin conductors will always have lower conductor loss than the thick conductor case, due to the higher effective area within which current flows through. This is true when uniform current is assumed across the effective area Ae and is increasingly valid for wide lines.

Conductance synthesis may be used to model the response of the composite conductor. In both the low and high frequency cases studied above for the composite conductor comprising of N conductors each of length I and effective current flow cross-sectional area AE, the composite conductor loss resistance may be written as:

$${R}_{c , N} = \frac{l}{( N σ ) \cdot A e} \qquad ( 8 )$$

This means that as far as conductor losses are concerned the composite conductor of order N is equivalent to a single conductor with an effective conductivity Nσ. Therefore by using the composite conductor technique any conductance may be synthesized by properly choosing the number N and the conductivity σ of the constituting conductors. To the limit where N→∞ the composite conductor is equivalent to a prefect conductor. The rate at which composite conductance increases with N is faster than the rate with which it would increase if a single conductor would, with increasing thickness, and this would be increasingly so at high frequencies.

In any of the above studied cases and due to relations (1) and (5) and one may see that in order to obtain a conductor loss resistance R_{N} for a single contractor at any frequency the equivalent single conductor that would achieve this would have to have a width N times the width of a single conductor in the composite ‘stacked’ conductor case. Since the area needed to implement this is proportional to the width W this means that the composite conductor has N times less area than the equivalent same conductor loss, single conductor.

It is only in the DC to low frequency range that the thickness may be effectively increased to give the same area with the composite stacked conductor. Unfortunately standard multilayer manufacturing processes do not offer conductor thickness as a variable to obtain low loss.

Therefore though the present composite conductor introduces complexity in the z direction the final cost measure will be area rather than volume, therefore the end cost of implementing such a composite ‘stacked’ conductor may be lower. In addition the technique lends itself to standard manufacturing processes.

The area advantage for the same conductor loss is a relative area improvement of N×100%.

The composite conductor as has been described so far may be used for low loss, high 0 inductor applications. In the microwave region in order to facilitate matching and optimum power transfer across wide bandwidths transmission lines are utilised where typically a conductor is in close proximity with a ground plane that effectively forms a low pass filter with very high cut-off frequencies. The ground plane is a conductor that retains a reference potential for the rest of the circuit.

A composite conductor transmission line as introduced above can be viewed as a transmission line formed by the combination of the proposed composite conductor and a reference conductive ground plane. The ground plane could also be such a composite conductor. Hence a class of transmission lines may be created based on the composite conductor concept. This class of transmission lines may be easily deduced from all the known planar conventional transmission line structures by simply replacing the single layer signal conductor of these lines with the composite conductor structure suggested in the previous paragraphs.

FIG. 5 demonstrates some examples of these lines for a simple composite conductor with only 2 constituent conductors. (N=2). Only the cross-sections of these lines is shown. FIG. 5(a) shows a composite microstrip. FIG. 5(b) shows a composite microstrip with composite ground plane. FIG. 5(c) shows a composite slot line. FIG. 5(d) shows a composite coplanar. FIG. 5(e) shows a composite (e) coplanar with a composite ground plane. FIG. 5(f) shows a composite grounded coplanar. FIG. 5(g) shows composite coupled strips. FIG. 5(h) shows a composite strip line (or suspended strip line). FIG. 5(i) shows a composite strip line with composite ground plane.

Other conventional transmission lines, for example as listed in B. C. Wadell, ‘Transmission Line Design Handbook’ Artech House, 1991, pages 73 to 148 may be translated into the composite conductor concept.

For most design purposes the most appropriate structures are likely to be the stacked composite microstrip and composite strip line transmission lines.

The conductor loss reduction in composite transmission lines will not be the same as in the case of the isolated composite conductor case. There are a number of reasons for this:

The current is not equally distributed across the constituent conductors of the composite conductor due to the presence of the ground plane.

There exist additional conductor losses on the ground plane, which may also be depended on the composite conductor geometrical form factor.

Conductor losses additionally depend on the impedance of the line apart from the conductor loss resistances.

It is possible that in some situations the composite conductor transmission line structure might support other spurious modes of propagation than the ones ordinarily supported in conventional transmission lines. However, For a large number of simulated cases mainly involving composite microstrip and strip line transmission lines no observable spurious mode behaviour was calculated by the inventor for frequencies up to 10 GHz.

It is possible that radiation losses may be higher in composite transmission lines due to larger number of the discontinuities involved in its construction and the vias radiation effects. Surface wave excitation might also be stronger. However, radiation losses always increase as frequency increases and depend on such parameters as, effective dielectric constant, conductor distance from ground plane, and width properties. By the judicious choice of the above parameters, (especially an upper limit frequency) any significant losses may be negligible. The inventor's investigations indicate that the radiation losses do not significantly affect performance up to at least 10 GHz in most typical design cases. Typically radiation losses become an issue when the size of the discontinuity involved is comparable to a good fraction of the wavelength. The simulations set out below support the above indication. Slightly higher radiation losses should only be expected when many composite conductor bends are involved

The series connected vias that form the composite transmission line when in large numbers may introduce stresses in the material structure that may puncture its reliability. However, as far as reliability is concerned due to multiple neighbouring vias there are ways to relax these stresses by using less vias or for example bending the composite transmission line to “break” the stress across a specific direction. The author is currently working on reduced via techniques.

The composite conductor structure is a more complex structure to manufacture and it may be more expensive to produce on a prototype and low volume production level. However, the ultimate cost in mass production is typically driven by area rather than volume the proposed concept will reduce the end cost and achieve miniaturised designs due to the inherent flexibility of the 3-D built up (in depth) of the formed circuits.

Detailed modelling of N=2 and N=3 composite conductor structures, which are the most practical cases that should be considered, will now be discussed.

Before proceeding with simulation results illustrating the low loss high Q properties of the proposed composite conductors in their transmission line form, the available technologies for implementing the proposed composite conductor technique will be discussed.

In order to investigate the general low loss properties of the composite conductor concept, examples have been simulated using the 2.5 D electromagnetic analysis software ADS Momentum. ADS Momentum is based on the method of moments using a mixed potential integral technique. It accounts for conductor, dielectric and radiation losses. Via to via coupling, via to planar conductor coupling and radiation from vias are also accounted for by using z-directed currents. Conductor surface roughness is not accounted for. It should be remembered that these simulations should be used as a means of relative comparison as opposed to an accurate absolute values comparison, since most electromagnetic simulators do not accurately predict the loss properties of transmission lines.

Two example cases were pursued: one with materials whose dielectric losses are relatively high and therefore comparable to conductor losses and another where dielectric losses are approximately an order of magnitude less in the frequency range from 0 to 10 GHz. Both cases are realistic examples of materials available in multilayer ceramic technology. Table 2 lists the material systems used for the simulations.

TABLE 2

| | High | Low |
|---|---|---|
| | Dielectric | Dielectric |
| | loss | Loss |
| Material System | (Material | (Material |
| Properties | System 1) | System 2) |
| Relative | 7.8 | 5 |
| Dielectric | | |
| Constant εr | | |
| Dielectric | 0.004 | 0.0005 |
| loss | | |
| tangent tanδ | | |
| Conductor | 6.2e7 | 5.8e7 |
| Conductivity σ | | |
| (S/m) | | |
| Ground | 6.2e7 | 5.8e7 |
| Conductor | | |
| Conductivity | | |
| (S/m) | | |
| Metal | 10 | 22 |
| conductor | | |
| thickness (um) | | |

This section compares the loss properties of a conventional conductor and a stacked composite conductor with N=2 for the case of the microstrip transmission line. Simulations using ADS Momentum for the 2 material systems described in table 2 were executed. FIGS. 6 and 7 show the exact geometrical characteristics of the microstrip transmission lines used for the simulations. Each figure corresponds to the high dielectric loss and low dielectric loss cases respectively. Simulations were performed to obtain the following properties

a. Total loss of a conventional 50 Ohms microstrip transmission line (Case A)

b. Total loss of a stacked composite conductor 50 Ohms transmission line with N=2 (Case B)

c. Total loss of a conventional 50 Ohm transmission line assuming a perfect conductor is used. (provides the dielectric and radiation loss only) (Case C)

d. Total loss of a stacked composite conductor 50 Ohms transmission line with N=2 assuming perfect conductors (provides the dielectric and radiation loss only) (Case D)

Cases C and D were effectively pursued for two purposes: to effectively simulate the superconductor case where only dielectric and radiation losses should exist; and in order to compare the extent to which radiation losses were significant in the case of the stacked composite conductor when compared to the conventional single conductor transmission line.

It should be noted that the widths of the conductors in the single conductor and composite conductor case, differ. The reason for this width difference is in order to present a 50 Ohm impedance for both cases so as to minimise the effect of reflection losses. To ensure this a return loss of more than 35 dB is required.

This may appear not to offer an objective comparison since if the same width were to be retained for the composite as for the as the single conductor case then fewer losses may have been potentially demonstrated. In reality though practical RF design is in almost all cases directed to designing a component to offer a specific impedance. Therefore, it is highly relevant to simulate the relative losses for the same impedance level. In this case an impedance of 50 Ohm was selected.

The results of the simulations are shown in FIG. 8. Both return loss and insertion loss is presented for a transmission line length of one inch. Both material systems are depicted. Table 3 summarizes the key results.

TABLE 3

| | Material system 1 (HDL*) | | Material system 2 (LDL*) | |
|---|---|---|---|---|
| | Single | Composite | Single | Composite |
| | Conductor | Conductor | Conductor | Conductor |
| | (A) | (B) | (A) | (B) |
| | (N = 1) | (N = 2) | (N = 1) | (N = 2) |
| Total Loss | 0.41 | 0.33 | 0.24 | 0.169 |
| dB/inch | | | | |
| (10 GHz) | | | | |
| Relative | — | −19.5 | — | −29.6 |
| change | | | | |
| (%)(dB) | | | | |

*HDL = High Dielectric Loss
*LDL = Low Dielectric Loss

It can be seen that with even the simplest case of N=2 the stacked composite conductor may result in significant overall loss reduction, the reduction being dependent on the dielectric material system the composite conductor is embedded. Another interesting feature is that when referring to the theoretical case of a perfect conductor, the overall losses due to dielectric/radiation losses in combination for both N=1 and N=2 conductors were the same. This result effectively means that the relative changes in radiation losses of the stacked composite conductor with N=2 are negligible when compared with the single conductor case.

The inductance and Q factor of microstrip and strip line resonators will now be simulated and compared for the stacked composite conductor for the cases N=1,2,3. The N=1 case represents the conventional single conductor. Both material systems used in the previous simulations were simulated in this set.

The structure used for the resonator/inductor test structure is shown in FIG. 9. In FIG. 9, the resistor R represents the total loss resistance. The unloaded quality factor Qui and inductance L may be deduced by the following set of relationships:

$${Q}_{u} = \frac{Im ( {Z}_{i n} )}{Re ( {Z}_{i n} )} L = \frac{Im ( {Z}_{i n} )}{2 π \cdot f} \qquad ( 9 )$$

The width of the conductor used to form both for strip line and microstrip resonators was fixed to W=12 mils=305 um. Its length was also fixed to 1-300 mils=7620 um.

FIGS. 10 and 11 show the configurations of the simulated shorted inductors for the microstrip case and the strip line case respectively, in each case with material systems.

The simulation results as calculated using ADS Momentum and relation 9 are shown in FIG. 12. Cases A, B, C on the graphs correspond to the cases N=1 , N=2, N=3 order composite conductors. Codes MS1_HDL and MS2_LDL on the graphs in FIG. 12 correspond to material system 1 (high dielectric loss=HDL) and material system 2 (low dielectric loss=LDL) respectively.

Tables 4 and 5 summarise the maximum Q factors and relative improvement of the Q factor when composite conductors are used.

TABLE 4

| | Material system 1 (High Dielectric Loss) | | | | | |
|---|---|---|---|---|---|---|
| | Microstrip | | | Strip line | | |
| | | Com- | Com- | | Com- | |
| | Single | posite | posite | Single | posite | Composite |
| Type of | Cond. | Cond. | Cond. | Cond | Cond. | Cond. |
| conductor | (N = 1) | (N = 2) | (N = 3) | (N = 1). | (N = 2) | (N = 3) |
| Q max | 101.9 | 152.4 | 170.1 | 79.85 | 115.6 | 125.8 |
| Relative Q | — | +49.6 | +66.9 | — | +44.8 | +57.5 |
| Improvement | | | | | | |
| (%) | | | | | | |

TABLE 5

| | Material system 2 (Low Dielectric Loss) | | | | | |
|---|---|---|---|---|---|---|
| | Microstrip | | | Strip line | | |
| | | Com- | Com- | | Com- | |
| | Single | posite | posite | Single | posite | Composite |
| Type of | Cond. | Cond. | Cond. | Cond. | Cond. | Cond. |
| conductor | (N = 1) | (N = 2) | (N = 3) | (N = 1) | (N = 2) | (N = 3) |
| Q max | 112.7 | 174.2 | 196.7 | 77.23 | 121.72 | 133 |
| Relative | — | +54.6 | +74.5 | — | +57.6 | +72.2 |
| Improvement | | | | | | |
| (%) | | | | | | |

It may also be observed from FIG. 12 that the inductance L for cases N=2 and N=3 decreases slowly as N increases with respect to the N=1 conventional conductor case. Typically only about 10% and 25% decrease of inductance is observed for the cases N=2 and N=3 respectively. If the width were to be doubled to obtain approximately the same loss for the N=2 case then the inductance would typically have changed more than 30%. On the other hand, the effective loss resistance decreases at a much faster rate as N increases, resulting in relative Q increases in the range of 45 to 75%. The relative improvement depends also on the dielectric material system where the conductor is embedded. The lower the dielectric loss the better the overall relative 0 improvement using this method.

Though the exact value of the relative increase may not be exactly representative of the non-theoretical situation due to the way the electromagnetic simulator calculates loss, it is nevertheless evident that the increase in Q is a “gross” effect.

In the simplest case of an RF design where typically it is desired to design for a specific impedance Zo, and a specific loss performance, in order to achieve with a single conductor the same loss performance as a composite conductor formed as a stacked via connected composite conductor with N=2 conductors, the width of the single conductor must be doubled. Also, in order to retain the same impedance Zo, the single conductor will have to use more layers to achieve the same impedance since the doubling of its width will significantly lower its impedance from its desired value Zo. Therefore it needs more distance from the ground plane to achieve the desired impedance. FIG. 13 shows a comparison of the two designs. It can be seen that not only more area is needed for the implementation of the single conductor case, but also more layers are required resulting in a much thicker and more expensive solution.

Typically for Zo˜50 the required height is 1.5 times more than the stacked composite conductor case to achieve the same loss performance. Therefore 3 times more volume/size is required resulting in higher cost. Greater cost and size would have been needed for achieving the same loss performance if a stacked composite conductor with N>2 conductors had been used in the comparison.

Simulations have indicated that the insertion loss in a typical transmission line can de lowered from −0.16 dB to −0.12 dB at 1 GHz by adding a second parallel conductor interconnected intermittently with the first as described above.

Preferably the interconnections between the strips/conductors are at a spacing/pitch of less than half the wavelength at which the composite conductor is to be used. This helps to prevent resonance. Within that range, the interconnections are preferably spaced as widely as possible so as to suppress resistive losses.

Generally the composite conductor can be formed by interconnection in one direction of conductive strips that extend principally in a second direction perpendicular to the first direction. The strips may have relatively little extend in the third direction perpendicular to both the first and second directions. Alternatively, the strips may have a substantial extent in the third direction in comparison to their extent in the second direction. In that case, composite structures could replace the strips, so that the composite conductor is formed of an array of thin strips running parallel in the second direction and disposed beside each other and interconnected, in the first and third directions. Where the dielectric is formed in layers, (which may typically each extend in the second and third directions, the strips may be deposited between the layers and be interconnected in the first direction by posts and/or vias and in the third direction by conductive material deposited with the strips themselves between the layers.

A ground plane can be formed using an extension of the principles described above. In comparison with a conventional integral planar ground plane, such a ground plane would comprise voids. The ground plane is preferably of a grid form, with square holes formed in it at equally spaced intervals. The holes could intersect one or more edges of the strip. The holes could be of another shape, for instance round. The ground plane could be provided by two or more strips interconnected at selected locations along their lengths. The ground plane could be formed by a single strip arranged in a serpentine or spiral fashion.

The stacked conductor technique offers not only comparatively low loss, but it is a also miniaturisation enabling arrangement which can permit multiple times less size and cost to implement a passive circuit, when a specific target loss performance is required. This is especially true when this stacked composite conductor is implemented in a Multilayer Ceramic Integrated Circuit (MCIC) technology.

A number of multi-conductor multilayer integrated circuit technologies are available for forming composite conductors. Such technologies may be classified in terms of their constituent dielectric materials:

Semiconductor IC Multilayer Processes.

Typically these comprise of a base semiconductor semi-insulating substrate which is used for fabrication of active devices. On top of this material typically 2-3 layers of thin dielectrics, usually polyimide, are deposited. These layers may support different conductors. Although normally no vias (or “microvias”) are used to connect the conductors residing on the thin dielectric layers, such vias/microvias could be used as a means of improving the Q using the composite conductor technique described herein. Micromachined on-chip 3-dimensional air-suspended high Q inductors have already been demonstrated with Q-50 and if the composite conductor technique were applied in addition, then the on-chip Q might be expected to reach the region of Q-80.

Multilayer Laminate Processes.

These processes are well-known and established as printed wired board (PWB) processes. Typically vias connecting 2 metal layers to form composite conductors are possible but typically vias are not filled. Hollow vias are used. This configuration will make conductor losses higher than would filled vias.

Multilayer Deposited Thin Film Processes.

These processes deposit typically very thin polyimide dielectrics on a base material. They offer the ability of built up of few dielectric layers, supporting conductors (2-6 typically) that may be connected by microvias. Typically stacked vias are also possible.

Multilayer Ceramic Thick Film Processes

These processes allow the very high numbers of dielectric/conductor layers to be built up. The number of layers typically is in the range from 5 to 50 or more. Filled vias connecting one or successive conductor layers are sometimes used. Multilayer ceramic technology may generally be the most suitable means for applying the composite conductor concept.

The reduction in overall conductor losses offered by composite conductors can offer many secondary benefits to circuits and systems. First, since conductor loss is turned into heat, lower conductor losses result in the dissipation of less heat. Additionally, the composite conductor offers increased area over which heat is dissipated due to its 3-D structure. The reduction in dissipated heat and the improvement in the efficiency of its dissipation helps in reducing temperature gradients which would potentially hinder the long term reliability of the system.

Thus embodiments of the composite conductor concept can offer some or all of the following benefits over analogous non-composite structures: a reduction in conductor loss; a reduced conductor area due to the 3-D structure of the composite conductor; higher wiring density for a comparable specific loss; potentially lower end cost due to the area reduction; improved noise figure and power efficiency of circuits/systems; improved heat dissipation properties of circuits/systems thus enhanced reliability; and improved the phase noise of oscillators since it enables higher resonator Q.

The composite conductor structure could be applied to a wide range of circuits and systems. These include resonaters, splitters, combiners, coupling structures, low loss interconnections, low loss filtering structures and so on.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A conductive structure having a conductor for carrying a signal at a one or more operating frequencies of the structure, the conductor comprising:
at least two electrically conductive strips; and
a ground plane associated with the conductor; wherein:
the at least two electrically conductive strips are spaced apart by a dielectric and arranged in parallel to extend from a first node to a second node, the conductive strips being interconnected between the nodes by at least one inter-strip electrically conductive connection through the dielectric; and
the maximum physical dimension of the or each inter-strip connection and the maximum physical separation of potentially successive inter-strip connections being equal to or less than one quarter of the free space wavelength corresponding to the minimum operating frequency of the structure; and wherein:
the ground plane is configured to as to include a plurality of localised voids therein.

2. A conductive structure as claimed in claim 1, wherein the electrically conductive strips and the or each inter-layer electrically conductive connection provide a transmission line.

3. A conductive structure as claimed in any preceding claim, wherein the ground plane extends parallel with the strips and spaced from them.

4. A conductive structure as claimed in any preceding claim, comprising at least three electrically conductive strips spaced apart by a dielectric and arranged in parallel to extend from the first node to the second node, the conductive layers all being interconnected between the nodes by inter-strip electrically conductive connections through the dielectric.

5. A conductive structure as claimed in any preceding claim, wherein the dielectric is a ceramic.

6. A conductive structure as claimed in any preceding claim, wherein the structure is formed by HTCC or LTCC.

7. A conductive structure as claimed in any preceding claim, wherein the strips are flat.

8. A conductive structure as claimed in any preceding claim, wherein the strips are planar.

9. A conductive structure as claimed in any preceding claim, wherein the dielectric is formed of a plurality of dielectric layers, the strips are located between the layers, and each inter-strip connections passes through at least one layer.

10. A conductive structure as claimed in any preceding claim, wherein the strips run parallel to each other.

11. A conductive structure as claimed in any preceding claim, comprising a dielectric located between the conductor and the ground plane.

12. A conductive structure as claimed in any preceding claim, wherein each inter-strip connection comprises a via or a post.

13. A conductive structure as claimed in any preceding claim, wherein adjacent strips are interconnected at a plurality of locations along their lengths.

14. A conductive structure as claimed in claim 13, wherein the number of locations is at least 5.

15. A conductive structure as claimed in claim 13, wherein the number of locations is at least 10.

16. A conductive structure as claimed in any of claims 13 to 15, wherein the locations are equally spaced.

17. A conductive structure as claimed in any of claims 13 to 16, wherein the strips are not interconnected between the said locations.

18. A conductive structure as claimed in any preceding claim, arranged in a circuit so as to be fed with radio frequency signals.

19. A conductive structure having a conductor extending from a first node to a second node and a ground plane for the conductor extending parallel with the conductor and spaced from it, the ground plane being configured to as to include a plurality of localised voids therein.

20. A conductive structure as claimed in claim 19, wherein the ground plane is flat.

21. A conductive structure as claimed in claim 19 or 20, wherein the ground plane comprises at least two strips interconnected at locations along their lengths so as to define the voices between the strips and the interconnections.

22. A conductive structure as claimed in any of claims 19 to 21, wherein the ground plane is arranged to operate in QTEM mode.

23. A conductive structure as claimed in any of claims 19 to 22, wherein the structure is formed by MCIT.

24. A conductive structure as claimed in claim 23, wherein the voids are regularly spaced.

25. A conductive structure substantially as herein described with reference to the accompanying drawings.
